(19) United States
(12) Patent Application Publication
(10) Pub. No.: US 2008/0052340 A1
(43) Pub. Date: Feb. 28, 2008

(54) METHOD AND SYSTEM FOR CONTENT ADVERTISING IN AD HOC NETWORKS

(75) Inventor: Jerald A. Hallmark, Gilbert, AZ (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Plantation, FL (US)

(21) Appl. No.: 11/467,858

(22) Filed: Aug. 28, 2006

(51) Int. Cl. G06F 15/16

(52) U.S. Cl. 709/200

(57) ABSTRACT

A method and system for incentive based content advertising using proxies in an ad hoc network. The method comprises of identifying (205) one or more proxy nodes that volunteer to provide content advertising services, based on one or more predefined parameters. Further, the method comprises of sharing (215) the information pertaining to one or more services between the server node and the one or more proxy nodes. The method also includes channeling (515) of incentives as payment to the one or more proxy nodes for providing content advertising services.

### FIELD OF THE INVENTION

The present invention relates generally to content advertising in ad hoc networks. More specifically, the present invention relates to a method and system for incentive based content advertising using proxies in ad hoc networks.

### BACKGROUND

An infrastructure-based wireless network typically includes a communication network with fixed and wired gateways. Many infrastructure-based wireless networks employ a mobile unit or host that communicates with a fixed base station that is coupled to a wired network. The mobile unit can move geographically while it is communicating over a wireless link to the base station.

In comparison to infrastructure-based wireless networks, such as cellular networks or satellite networks, ad hoc networks are self-forming networks that can operate in the absence of any fixed infrastructure, and in some cases the ad hoc network is formed entirely of mobile nodes. An ad hoc network typically includes a number of geographically distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network. Links or connections between these nodes can change dynamically in an arbitrary manner as existing nodes move within the ad hoc network, as new nodes join or enter the ad hoc network, or as existing nodes leave or exit the ad hoc network.

In an ad hoc system a server node may switch from an active mode to an inactive mode to optimize power consumption. The inactive mode of the server node can be a sleep mode during which other nodes are not able to access the services as offered by the server node. Therefore, the server node in its inactive state may miss an opportunity to provide its services to other nodes that are interested in the services available through the server node. For example, if a mobile node passes by the communication window of the server node, and the server node is inactive at that time, the mobile node may not become aware of the services available by or through the server node.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary embodiment of a network for implementing incentive based content advertising using proxies in accordance with some embodiments of the present invention.

FIG. 2 is a flow diagram illustrating a method for incentive based content advertising using proxy nodes in an ad hoc network, in accordance with an embodiment of the present invention.

FIG. 3 is a flow diagram illustrating a method for communicating with one or more prospective proxy nodes and subsequent access of the server by one or more proxy nodes, in accordance with an embodiment of the present invention.

FIG. 4 is a flow diagram illustrating a method for accessing and retrieving information about the advertised services from one or more proxy nodes by one or more client nodes, in accordance with an embodiment of the present invention.

FIG. 5 is a flow diagram illustrating a method for information transaction between a server and one or more proxy nodes, in accordance with an embodiment of the present invention.

FIG. 6 is a block diagram of a system for advertising information corresponding to at least one service offered by a server node in an ad hoc network, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to incentive based content advertising in ad hoc networks. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the present invention described herein may be comprised of one or more conventional processors and unique stored program instructions that control the one or more processors to implement, in conjunction with certain non-processor circuits, some, most, or all of the functions of method and system for incentive based content advertising using proxies in ad hoc networks described herein. The non-processor circuits may include, but are not limited to, a radio receiver, a radio transmitter, signal drivers, clock circuits, power source circuits, and user input devices. As such, these functions may be interpreted as steps of a method to perform incentive based content advertising in ad hoc networks. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

To alleviate some of the issues discussed in the background section previously herein, a server node can share information regarding the services offered by the server node with neighbor nodes that are within close proximity to the server node. These neighbor nodes, in turn may volunteer as proxy nodes to provide the information corresponding to the services to other mobiles nodes interested in the services during the inactive mode of the server node. In the state of the art content advertising model in ad hoc networks, one or more proxy nodes volunteer to provide content advertising service on a complementary basis. The mobile proxy nodes in an ad hoc network operate on limited power resources. When proxy nodes volunteer for content advertising service, it may be challenging to sustain the rendering of content advertising service while continuing to maintain the proxy node's performance.

The present invention provides a system and method for incentive based content advertising using proxies in an ad hoc network. The method comprises channeling incentives for the content advertising service provided by one or more proxy nodes in the ad hoc network. The method further comprises estimating the transaction level pertaining to the content advertising service provided by one or more proxy nodes to one or more client nodes. The estimation of the transaction level includes calculating the payment for the transactions.

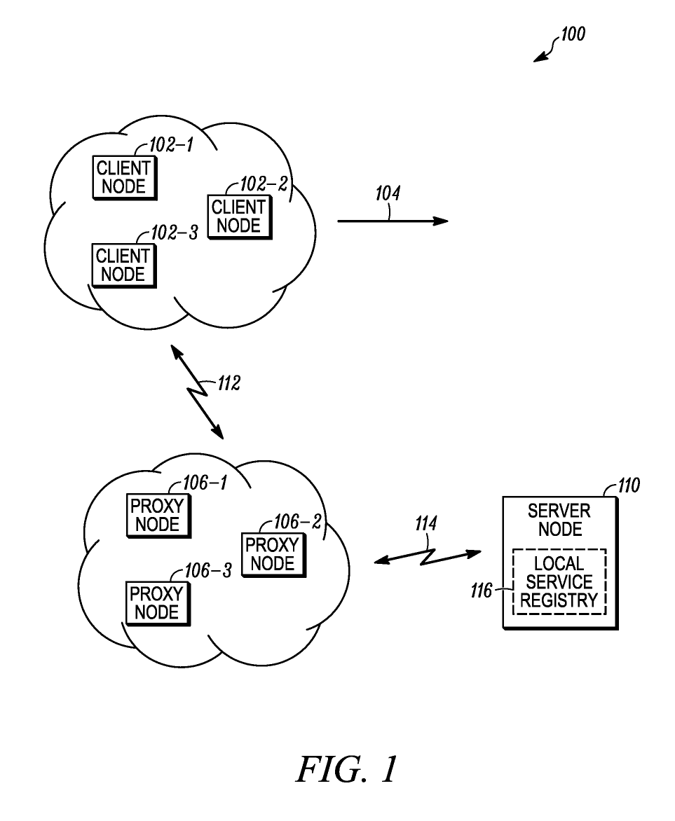

FIG. 1 illustrates an exemplary embodiment of an ad hoc network 100 including content advertising using proxies. The ad hoc network 100 comprises one or more client nodes, one or more proxy nodes 106-n and a server node 110. Specifically, the ad hoc network 100 includes a plurality of mobile wireless nodes 102-1 through 102-n. For the purposes of discussion the nodes 102-1 through 102-n are collectively referred to as “Client nodes”. According to the exemplary embodiment of the present invention the one or more client nodes 102-n travel in a direction 104. Also, the ad hoc network 100 comprises a plurality of nodes 106-1 through 106-n. For the purposes of discussion, the plurality of nodes 106-1 through 106-n are collectively referred to as “Proxy nodes”. Further, the ad hoc network 100 also comprises a server node 110. Communication between one or more proxy nodes 106-n and the server node 110 takes place through a communication medium 114. Communication between one or more client nodes 102-n and the one or mode proxy nodes 106-n takes place through a communication medium 112.

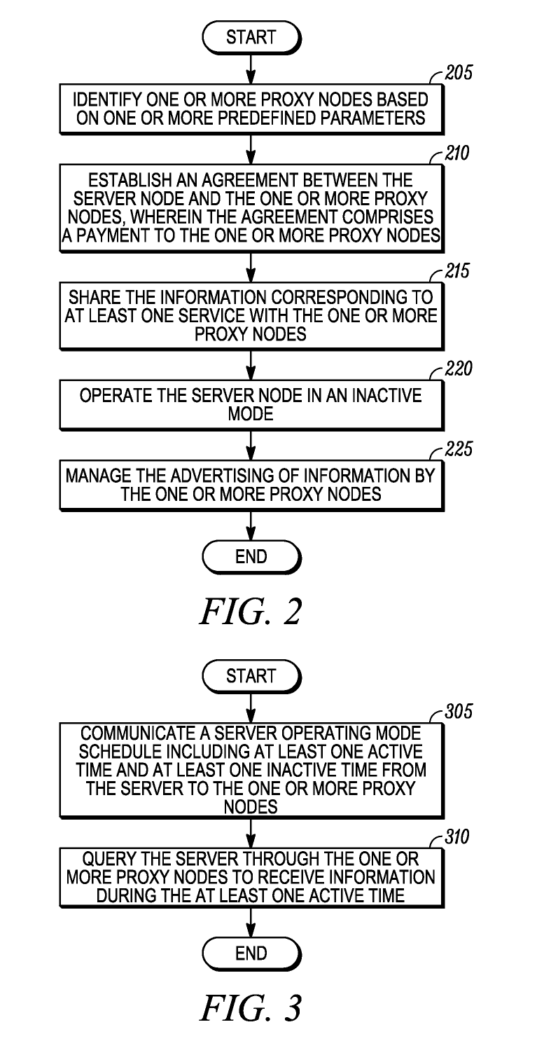

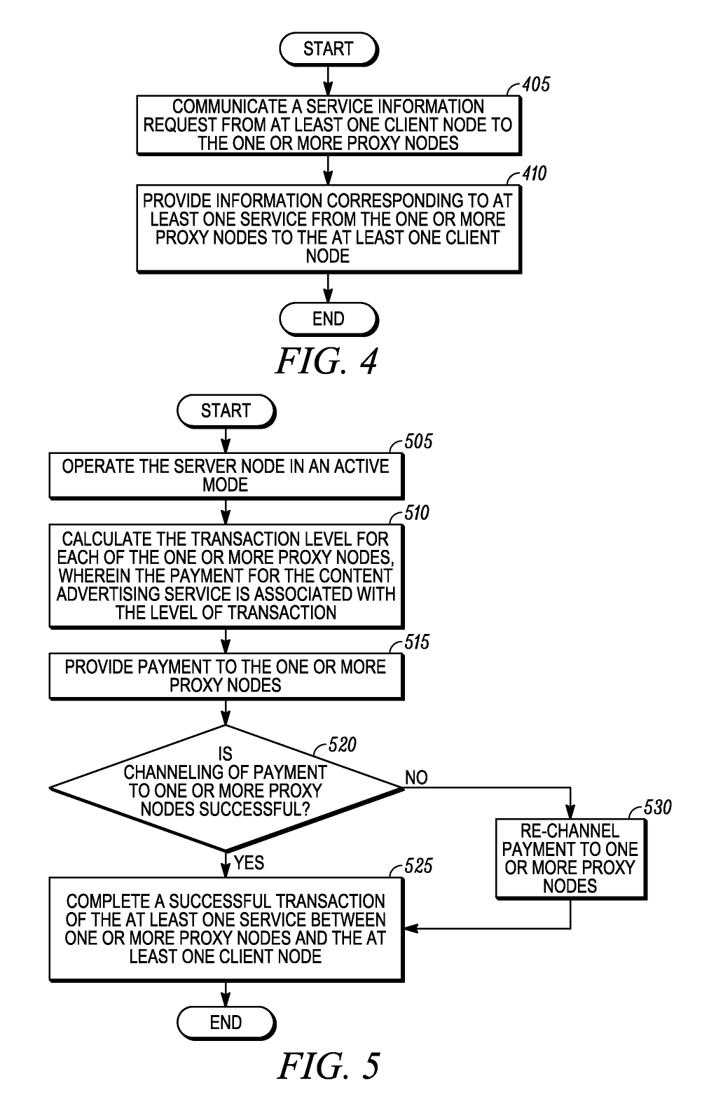

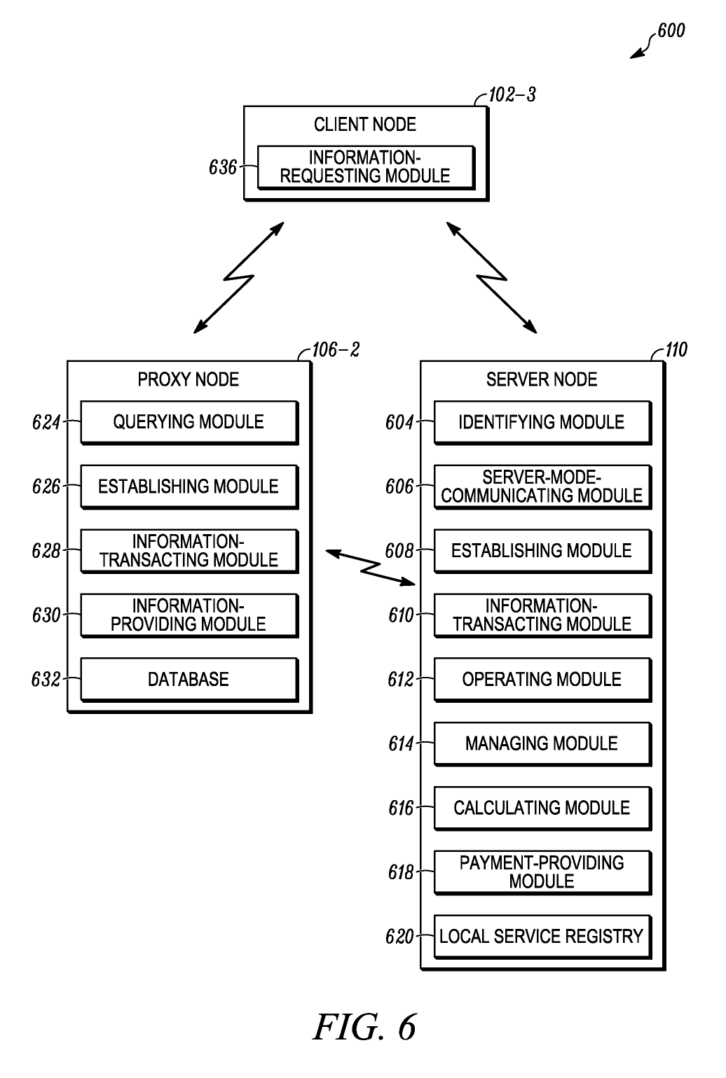

In an exemplary embodiment of the present invention, the client nodes 102-n can be contained within, for example, automobiles, aircrafts, or ships traveling in various directions. The method for incentive based content advertising using proxy nodes 106-n in an ad hoc network is described in conjunction with FIG. 1, FIG. 2, FIG. 3, FIG. 4, FIG. 5 and FIG. 6 in accordance with the present invention.

FIG. 2 is a flow diagram illustrating a method for incentive based content advertising using proxy nodes 106-n in the ad hoc network 100, in accordance with some embodiments of the present invention. The incentive based content advertising service primarily requires the identification of one or more prospective proxy nodes 106-n. The one or more prospective proxy nodes 106-n, for example, can volunteer to provide information corresponding to one or more services offered by the server node 110. The information corresponding to the one or more services offered by the server node 110 can be service details corresponding to each service and pricing details corresponding to each service.

In the ad hoc network 100, a server node 110 can switch to a lower power mode in order to optimize power consumption, thereby enhancing battery life. Further, one or more client nodes 102-n in the ad hoc network 100 have relative mobility with respect to one or more proxy nodes 106-n and/or to the server node 110. Hence, the mobility of the one or more client nodes 102-n constrains the communication interaction time with the one or more proxy nodes 106-n and the server node 110. When the server node 110 switches to a low power sleep mode, the communication interaction time between the one or more client nodes 102-n and the server node 110 is further constrained. The resultant limited interaction time detrimentally affects the communication between the one or more client nodes 102-n and the server node 110, during a query or data response exchange session.

Referring back to FIG. 2, at step 205, one or more nodes are identified as proxy nodes 106-n based on one or more predefined parameters. In an exemplary embodiment of the present invention, the one or more predefined parameters comprise one or more of a spatial distance between the server node 110 and one or more proxy nodes 106-n, and a protocol compatibility for establishing communication between the server node 110 and the one or more proxy nodes 106-n. The one or more nodes 106-n that are in close proximity to the server node 110 may volunteer to provide content advertising service. Based on the one or more predefined parameters, one or more nodes 106-n can be recognized as proxy nodes that can provide content advertising service for a predetermined period of time.

At step 210, an agreement is established between the server node 110 and the one or more proxy nodes 106-n. In an embodiment of the present invention, for example, the agreement comprises channeling incentives in the form of a micro-payment as a service credit to the one or more proxy modes 106-n agreeing to proxy for the content advertising service. The agreement may also include a scheduled time period during which the one or more proxy nodes 106-n can offer the content advertising service. A protocol can be established for a content advertising service, using one or more proxy nodes 106-n, that may also govern the incentives offered to the one or more proxy nodes 106-n by the server node 110. The agreement between the one or more proxy nodes 106-n and the server node 110 can be devised based on the established protocol. When an agreement is established between the one or more proxy nodes 106-n and the server node 110, the one or more proxy nodes 106-n can be informed about the period of validity of the agreement. Further, the agreement may also include terms pertaining to a revenue sharing scheme between the server node 110 and the one or more proxy nodes 106-n.

In response to establishing an agreement between the server node 110 and the one or more proxy nodes 106-n, the server node 110 shares information corresponding to one or more services offered by the server node 110 with the one or more proxy nodes 106-n at step 215. In an embodiment of the present invention, the server node 110 has a local service registry 116 (see FIG. 1) that comprises a list of advertisements for various services. The local service registry 116 contains profiles for each of the services and various attributes corresponding to the services. The profiles of the advertisements can be categorized into different segments based on the nature of the advertisements. The information pertaining to the one or more services offered by the server node 110 is shared between the server node 110 and the one or more proxy nodes 106-n through a client-server interface. The client-server interface serves as a communication medium between the server node 110 and the one or more proxy nodes 106-n through a predefined protocol.

When one or more proxy nodes 106-n are interfaced with the server node 110, the server node 110 can allot specific segments of advertisement profiles to the one or more proxy nodes 106-n depending on the agreement. In an exemplary embodiment of the present invention, the server node 110 may allot a large segment of advertisement profiles to one or more proxy nodes 106-n that volunteer to provide content advertising service for a longer duration of time. Alternatively, the server node 110 may allot a smaller segment of advertisement profiles to one or more proxy nodes 106-n that volunteer to provide content advertising service for a shorter duration of time.

Once the information corresponding to one or more services offered by the server node 110 is shared with the one or more proxy nodes 106-n, the server node 110 is operated in an inactive mode at step 220. During the inactive mode, the server node 110 is operated in a low power sleep mode. In a low power sleep mode, access to the server node 110 by one or more client nodes 102-n is not available. Therefore, one or more client nodes 102-n cannot access the one or more services offered by the server node 110 during the inactive mode.

At step 225, the content advertising service provided by the one or more proxy nodes 106-n is managed in a distributed manner. When one or more proxy nodes 106-n interface with the server node 110, the server node 110 allots information corresponding to the one or more services to one or more proxy nodes 106-n based on the agreement. The server node 110 may associate the one or more proxy nodes 106-n with unique identifiers (IDs) for managing the advertisement of the information corresponding to the one or more services and their corresponding payment. The unique IDs associated with the one or more proxy nodes 106-n can be used to identify specific proxy nodes among a distributed network of proxy nodes 106-n.

FIG. 3 is a flow diagram illustrating the process of communication between a server node 110 and one or more proxy nodes 106-n for sharing information pertaining to the one or more services offered by the server node 110 in accordance with some embodiments of the present invention. Once the one or more proxy nodes 106-n are identified, a server operating mode schedule is communicated to the one or more proxy nodes 106-n at step 305. The server operating mode schedule information comprises one or more active timeframes and one or more inactive timeframes for the server node 110. During the one or more active timeframes the server node 110 is available for communicating with the one or more proxy nodes 106-n and the one or more client nodes 102-n. The client nodes 102-n can access the server node 110 for retrieving the contents of various services during the active mode of the server node 110.

At step 310, during one or more active timeframes of the server node 110, the one or more proxy nodes 106-n interact with the server node 110. Consequently, the one or more proxy nodes 106-n query the server node 110 for obtaining information pertaining to the one or more services offered by the server node 110.

FIG. 4 is a flow diagram illustrating the process of communication between one or more client nodes 102-n and one or more proxy nodes 106-n in accordance with some embodiments of the present invention. At step 405, one or more client nodes 102-n make a request to the one or more proxy nodes 106-n for information regarding one or more services offered by the server node 110.

At step 410, upon receiving a request from one or more client nodes 102-n for information regarding the one or more services, the one or more proxy nodes 106-n service the requested information. The information pertaining to one or more services are stored in a database within the one or more proxy nodes 106-n. The one or more proxy nodes 106-n locate the requested information within their database and provide them to the one or more client nodes 102-n.

The one or more proxy nodes 106-n can notify the one or more client nodes 102-n about the cost of accessing and retrieving the information corresponding to one or more services, prior to presenting the requested information. The cost of accessing and retrieving the information corresponding to one or more service may, for example, depend upon the type of advertisement and the contents requested by the one or more client nodes 102-n. The contents of advertisements that have more attributes may be associated with a higher cost. Whereas the contents of advertisements that have lesser number of attributes may be associated with a lower cost of access and retrieval.

In an embodiment of the present invention, if a specific proxy node 106-n to which an advertisement information is requested, knows the availability of the requested advertisement information in other proxy nodes 106-n, the one or more client nodes 102-n can be directed to communicate with the other corresponding one or more proxy nodes 106-n that have the requested advertisement information. Each transaction between the one or more proxy nodes 106-n and the corresponding one or more client nodes 102-n is associated with a transaction ID. The server node 110, during its active state, identifies the transactions between the one or more proxy nodes 106-n and one or more client nodes 102-n using the transaction ID. The transactions IDs are stored in the database of the one or more proxy nodes 106-n.

FIG. 5 is a flow diagram illustrating post-inactive mode communication between the server node 110 and the one or more proxy nodes 106-n in accordance with some embodiments of the present invention. The server node 110 is switched from the low power inactive mode to the active mode at step 505. On switching to the active mode, the server node 110 is ready to communicate with the one or more proxy nodes 106-n. Consequently, the server node 110 interacts with the one or more proxy nodes 106-n for obtaining the transaction information regarding the content advertising service. The transaction information may comprise the number of requests received by the one or more proxy nodes 106-n from one or more client nodes 102-n for accessing information about one or more services. The transaction information may further comprise the amount of requests served by the one or more proxy nodes 106-n to one or more client nodes 102-n successfully.

At step 510, the server node 110 calculates the payment or the incentives to be channeled to the one or more proxy nodes 106-n by analyzing the level of each of the transactions of the one or more proxy nodes 106-n. The amount of payment is associated with the level of transaction that takes place between the one or more proxy nodes 106-n and the one or more client nodes 102-n. A higher level of transaction may mean that the content advertising service pertaining to one or more service results in the sale of the corresponding one or more services. Also, a higher level of transaction may be realized when the information specific to one or more services is requested by one or more client nodes 102-n more frequently, creating a demand.

At step 515, the server node 110 channels the payment corresponding to the one or more transactions relating to the one or more proxy nodes 106-n. The incentives channeled to the one or more proxy nodes 106-n is high for high-level transactions, and for low level transactions the corresponding incentives are channeled is lower, for example as micro-payments. The server node 110 identifies the one or more transactions corresponding to the one or more proxy nodes 106-n using the transaction IDs stored in the database of the one or more proxy nodes 106-n. Subsequently, the server node 110 calculates the payment for the one or more transactions relating to the one or proxy nodes 106-n, after the level of the one or more transactions are analyzed. The calculated payments can be channeled through a secure interface between the server node 110 and the one or more proxy nodes 106-n.

At step 520, the successful channeling of payment to the one or more proxy nodes 106-n is checked. The channeling of payment is successful if the one or more advertised services result in the sale of the one or more services. Further, at step 525 when the one or more proxy nodes 106-n receive the payment channeled by the server node 110 corresponding to the one or more transactions, the channeling of payment is successful. Consequently, the successful channeling of payment to the one or more proxy nodes 106-n is registered in the local service registry 116 of the server node 110.

When the channeling of the payments to the one or more proxy nodes 106-n by the server node 110 is unsuccessful, the unsuccessful channeling of payment is registered in the local service registry 116 of the server node 110. Subsequently, the server node 110 re-channels the payment corresponding to the one or more transactions to the one or more proxy nodes 106-n at step 530. The re-channeling of the payment is further registered in the local service registry 116 of the server node 110.

FIG. 6 is a block diagram of an exemplary system 600 for advertising information corresponding to one more services offered by a server node 110 in an ad hoc network, in accordance with some embodiments of the present invention. Those skilled in the art will appreciate that the system 600 can comprise more than one server nodes, the one or more proxy nodes 106-n and the one or more client nodes 102-n. However, for the sake of clarity, the system 600 is shown to comprise the server node 110, the proxy node 106-2 and the client node 102-3.

The server node 110 comprises an identifying module 604 that identifies the one or more proxy nodes 106-n based on one or more predefined parameters. In an exemplary embodiment of the present invention, the predefined parameter can be the spatial distance between the server node 110 and the one or more proxy nodes 106-n. One or more potential proxy nodes that are in close proximity to a server node 110 may volunteer to provide content advertising service. The identifying module 604 recognizes a node as the proxy node 106-2 that can provide content advertising service for a predetermined period of time. A compatibility protocol may be devised for establishing communication between the server node 110 and the proxy node 106-2. Based on the compatibility protocol, the identifying module 604 can facilitate the identification of the proxy node 106-2 by the server node 110.

The server-mode-communicating module 606 communicates information corresponding to the current and future operating mode of the server node 110 to the proxy node 106-2. The server operating mode schedule information comprises one or more active timeframes and one or more inactive timeframes for the server node 110. During the one or more active timeframes the server node 110 is available for communicating with the proxy node 106-2 and the client node 102-3. The client node 102-3 can access the server node 110 for retrieving the contents of various services during the active mode of the server node 110.

During one or more active timeframes of the server node 110, the proxy node 106-2 communicatively interacts with the server node 110. Consequently, the proxy nodes 106-2 can query the server node 110 for obtaining information pertaining to the one or more services offered by the server node 110. The querying module 624 of the proxy node 106-2 facilitates querying the server node 110, by the proxy node 106-2 for sharing information regarding the one or more services. On receiving the queries from the proxy node 106-2, the server node 110 shares information corresponding to content advertising service to the proxy node 106-2.

An establishing module 608 further comprised in the server node 110 and an establishing module 626 included in the proxy node 106-2 establishes an agreement between the server node 110 and the proxy node 106-2. In an embodiment of the present invention, the agreement comprises of channeling incentives in the form of micro-payment as a service credit to the proxy node 106-2. The agreement may also include a scheduled time period during which the proxy node 106-2 can offer the content advertising service. The establishing module 608 may operate on an established protocol for content advertising service using the more proxy node 106. The established protocol may also govern the incentives offered to the proxy node 106-2 by the server node 110. The establishing module 608 may also inform about the period of validity of the agreement to the proxy node 106-2.

Once, the establishing module 608 establishes an agreement between the server node 110 and the proxy node 106-2, an information-transacting module 610 in the server node 110 shares information corresponding to the one or more services, between the server node 110 and the proxy node 106-2. An information-transacting module 628 is comprised within the proxy node 106-2 for facilitating transaction of information to the server node 110. The information-transacting module 610 of the server node 110 and the information-transacting module 628 facilitates sharing of information pertaining to the one or more services, between the server node 110 and the proxy node 106-2 through a client-server interface.

Further, the information-transacting module 610 of the server node 110 and the information-transacting module 628 of the proxy node 106-2 includes an interface that operates as a communication medium between the server node 110 and the proxy node 106-2 through a predefined protocol. The server node 110 is operated in an inactive mode by the operating module 612. In the inactive mode, the server node 110 is not available for access by the client nodes 102-n or the proxy nodes 106-n. Further, the managing module 614 manages the content advertising service provided by the proxy node 106-2 in a distributed manner. When the proxy node 106-2 interfaces with the server node 110, the managing module 614 allots information corresponding to the one or more services to the proxy node 106-2 based on the agreement. The managing module 614 may associate the proxy node 106-2 with unique identifiers (IDs) for managing the advertisement of the information corresponding to the one or more services and their corresponding payment. The unique IDs associated with the one or more proxy nodes 106-n can be used to identify a specific proxy node among a distributed network of proxy nodes 106-n. The proxy node 106-2 communicates with the server node 110 for sharing information pertaining to the one or more services, in accordance with an embodiment of the present invention. When the identifying module 604 of the server node 110, identifies the proxy node 106-2 the server node 110 interacts with the proxy node 106-2.

The system 600 further facilitates communication between the client node 102-3 and the proxy node 106-2, in accordance with an embodiment of the present invention. The client node 102-3 comprises of an information-requesting module 636 and the proxy node 622-2 further comprises of an information-providing module 630. The information-requesting module 636 communicates a request from the client node 102-3 to the proxy node 106-2 for obtaining information regarding one or more services.

The information-providing module 630 receives a request from the client node 102-3 for information corresponding to one or more services. Thereafter, the information-providing module 630 locates the requested information from a database 632 included within the proxy node 106-2 and serves the requested information through the proxy node 106-2.

In the post-inactive mode of the server node 110, communication between the proxy node 106-2 and the server node 110 is facilitated in accordance with an embodiment of the present invention. The server node 110 further comprises of, a calculating module 616 and a payment-providing module 618. The calculating module 616 calculates the payment or incentives to be channeled to the proxy nodes 106-2. The calculating module 616, calculates the payment for each of the transactions by analyzing the level of each of the transactions pertaining to the proxy node 106-2.

The payment-providing module 618 channels the payment corresponding to the one or more transactions relating to the proxy node 106-2. The payment-providing module 618 channels higher payment for high-level transactions. For low-level transactions, the payment-providing module 618 channels micro-payments to the proxy nodes 106-2. The payment-providing module 618 can also identify the one or more transactions corresponding to the proxy node 106-2 using the transaction IDs stored in a database 632 of the proxy node 106-2. Moreover, the payment-providing module 618 can channel the calculated payments through a secure interface between the server node 110 and the proxy node 106-2. The payment-providing module 618 successfully channels the calculated payment to the proxy node 106-2, if the one or more advertised services result in the sale of the one or more services. Further, when the node 106-2 receives the payment channeled by the payment-providing module 618 corresponding to the one or more transactions, the channeling of payment is successful. Consequently, the successful channeling of payment to the proxy node 106-2 is registered in the local service registry 620 of the server node 110 by the payment-providing module 618.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A method for advertising an information corresponding to at least one service offered by a server node, in an ad hoc network comprising:
identifying one or more proxy nodes based on one or more predefined parameters;
establishing an agreement between the server node and the one or more proxy nodes, wherein the agreement comprises a payment to the one or more proxy nodes;
sharing the information corresponding to the at least one service with the one or more proxy nodes;
operating the server node in an inactive mode; and
managing the advertising of the information by the one or more proxy nodes.

2. A method for advertising an information corresponding to at least one service as claimed in claim 1, wherein the information corresponding to the at least one service comprises at least one of a service details corresponding to each service and pricing details corresponding to each service.

3. A method for advertising an information corresponding to at least one service as claimed in claim 1, wherein the predefined parameters can be at least one of a spatial relationship between the server node and the one or more proxy nodes and a protocol compatibility for establishing communication between the server node and the one or more proxy nodes.

4. A method for advertising information corresponding to at least one service as claimed in claim 1, wherein the agreement comprises at least one of a revenue sharing agreement and a service credit agreement.

5. A method for advertising an information corresponding to at least one service as claimed in claim 1 further comprising:
communicating a service information request from at least one client node to the one or more proxy nodes; and
providing the information corresponding to the at least one service from at least one of the one or more proxy nodes to the at least one client node.

6. A method for advertising an information corresponding to at least one service as claimed in claim 5, further comprising:
operating the server node in an active mode; and
providing the payment to the one or more proxy nodes.

7. A method for advertising information corresponding to at least one service as claimed in claim 6, wherein the payment comprises a payment for the one or more proxy nodes management of the advertising of information while the server node is operating in the inactive mode.

8. A method for advertising an information corresponding to at least one service as claimed in claim 6, further comprising:
calculating a transaction level for each of the one or more proxy nodes, and
wherein the payment is associated with the transaction level.

9. A method for advertising an information corresponding to at least one service as claimed in claim 6, further comprising after the providing step:
completing a successful transaction of the at least one service between at least one of the one or more proxy nodes and the client node, and
wherein the payment comprises a payment for the successful transaction.

10. A method for advertising an information corresponding to at least one service as claimed in claim 9 wherein the payment comprises a payment value associated with the value of the at least one service.

11. A method for advertising an information corresponding to at least one service as claimed in claim 9 wherein the payment comprises a transaction payment,
and wherein the payment further comprises a sales payment when the successful transaction comprises a service sale.

12. A method for advertising an information corresponding to at least one service as claimed in claim 1, further comprising:
communicating a server operation mode schedule including at least one active time and at least one inactive time from the server to the one or more proxy nodes; and
querying the server by the one or more proxy nodes to receive the information during the at least one active time.

13. A system for advertising an information corresponding to at least one service offered by a server node, in an ad hoc network comprising:
an identifying module, the identifying module identifying one or more proxy nodes based on one or more predefined parameters;
an establishing module, the establishing module establishing an agreement between the server node and the one or more proxy nodes, wherein the agreement comprises a payment to the one or more proxy nodes;
an information-transacting module, the information-transacting module shares the information corresponding to the at least one service with the one or more proxy nodes; and estimates the cost involved pertaining to the at least one service with the one or more proxy nodes:
an operating module, the operating module operating the server node in an inactive mode; and
a managing module, the managing module managing the advertising of the information by the one or more proxy nodes.

14. A system for advertising an information corresponding to at least one service as claimed in claim 13 further comprising:
an information-requesting module, the information-requesting module requesting information regarding one or more services from at least one client node to one or more proxy nodes; and
an information-providing module, the information providing module providing the information corresponding to the at least one service from at least one of the one or more proxy nodes to the at least one client node.

15. A system for advertising an information corresponding to at least one service as claimed in claim 14 further comprising:
an operating module, the operating module operates the server node in an active mode;
a calculating module, the calculating module calculating a transaction level for each of the one or more proxy node; and
a payment-providing module, the payment-providing module providing the payment to one or more proxy nodes.

16. A system for advertising an information corresponding to at least one service as claimed in claim 13, further comprising:
a server-mode-communicating module, the server-mode-communication module communicating a server operation mode schedule including at least one active time and at least one inactive time from the server to the one or more proxy nodes; and
a querying module, the querying module querying the server by the one or more proxy nodes to receive the information during the at least one active time.
